(19) United States
(12) Patent Application Publication
(10) Pub. No.: US 2007/0090102 A1
(43) Pub. Date: Apr. 26, 2007

(54) Device and method for welding drum in drier

(75) Inventor: Myongdeok Kim, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/555,596

(22) PCT Filed: Jun. 10, 2005
(86) PCT No.: PCT/KR05/01744

§ 371 Date: Nov. 7, 2006

(30) Foreign Application Priority Data
Jun. 24, 2004 (KR) 2004-47633

(51) Int. Cl. B23K 9/00

(52) U.S. Cl. 219/137 R; 219/160

(57) ABSTRACT

An apparatus for welding a drum in a dryer and method thereof are disclosed. The present invention includes a welding electrode having a welding groove on which contact portions of an object to be welded are put and a heat dispersion end block provided to ends of the contact portions in a direction of welding the contact portions to prevent heat from being concentrated on the ends of the contact portions in welding the ends of the contact portions. Accordingly, the contact portions of the metal-based drum sheet can be welded to their ends without causing the welding-affected burn by preventing heat from being concentrated on the ends of the contact portions, whereby the welded strength of the contact portions is raised. And, by raising the welded strength of the contact portions, the rigidity of the cylindrically welded drum is enhanced to extend an endurance of the drum.

### TECHNICAL FIELD

The present invention relates to an apparatus for welding a drum in a dryer and method thereof. Although the present invention is suitable for a wide scope of applications, it is particularly suitable for previously preventing a welding-affected burn of ends of contact portions of a metal-based drum sheet in welding the contact portions.

### BACKGROUND ART

Generally, a dryer is an apparatus for drying a wet object to be dried (e.g., clothes or laundry) automatically. The dryer dries the object to be dried within a drum in a manner of heating an outdoor air by a heater and introducing the heated hot air into a drum that is rotating.

The drum is manufactured in a manner of welding contact portions of a metal-based sheet of stainless steel or the like to form a cylindrical shape, pipe-forming both ends of the cylindrical shape, working a bead on a central part of the cylindrical shape, and hemming each rim of both of the ends of the cylindrical shape.

To form the drum sheet into the cylindrical shape by welding the contact portions of the metal-based drum sheet, a device for welding a dryer drum according to a related art is explained with reference to the attached drawings as follows.

FIG. 1 is layout of drum sheet to weld contact portions of a drum sheet using a device for welding a dryer drum according to a related art, and FIG. 2 is a cross-sectional diagram taken along the contact portions in FIG. 1.

Referring to FIG. 1 and FIG. 2, contact portions of a drum sheet 1 is welded in a following manner using a drum welding device in a dryer according to a related art.

First of all, the drum sheet 1 made of a metal-based material such as stainless steel and the like is rolled to have a cylindrical shape.

And, contact portions la of the rolled drum sheet 1 are welded together to form a cylindrical drum sheet 1.

In particular, the contact portions la of the drum sheet 1 are put on a welding groove 3a of a welding electrode 3 provided to a welding die 2. The contact portions la are then welded to form the cylindrical drum sheet while put on the welding groove 3a.

However, the related art welding device has the following problem in welding the contact portions 1a of the drum sheet 1.

Namely, in welding the entire contact portions la of the drum sheet 1, a welded end between the contact portions la has a welding-affected burn so that the contact portions 1a are not completely welded together.

In particular, in case of welding ends of the contact portions 1a of the drum sheet 1, heat generated from arc is focused on the ends of the contact portions 1a so that the ends of the contact portions 1a are melted in part to result in the welding-affected burn.

Hence, a crack or notch occurs in the ends of the contact portions 1a having the welding-affected burn and then grows gradually to cause a break to the contact portions 1a.

To prevent the problem, the contact portions 1a are not welded to their ends so that the ends of the contact portions 1a are not welded.

However, in case of forming the cylindrical drum by not welding the ends of the contact portions, a crack or notch is generated from the non-welded ends in another forming or molding process of the cylindrical drum after completion of the welding or in using the drum after completion of the forming or molding process.

Hence, the crack or notch still grows to pass through a cross-section of the entire welded portion to cause the break to the contact portions 1a.

### DISCLOSURE OF THE INVENTION

Accordingly, the present invention is directed to an apparatus for welding a drum in a dryer and method thereof that substantially obviate one or more of the problems due to limitations and disadvantages of the related art.

An object of the present invention is to provide an apparatus for welding a drum in a dryer and method thereof, in which contact portions of a metal-based drum sheet are accurately welded to their ends without causing a welding-affected burn by preventing heat from being concentrated on the ends of the contact portions and by which welded strength of the contact portions is raised to enhance overall rigidity of the drum.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a welding apparatus according to the present invention includes a welding electrode having a welding groove on which contact portions of an object to be welded are put and a heat dispersion end block provided to ends of the contact portions in a direction of welding the contact portions to prevent heat from being concentrated on the ends of the contact portions in welding the ends of the contact portions.

Preferably, the heat dispersion end block adheres closely to the ends of the contact portions. And, the heat dispersion end block is formed of a substance having high thermal conductivity such as Cu, Fe and the like. Moreover, a vertical thickness of the heat dispersion end block is configured greater than a thickness of the object to be welded.

Preferably, a length of the welding groove is configured greater than that of the contact portions of the object to be welded.

Preferably, the welding apparatus further includes a transport means for making the heat dispersion end block adhere closely to the ends of the contact portions according to a length of the contact portions of the object to be welded.

More preferably, the transport means includes a transport bar fixed to one side of the heat dispersion end block and a transport cylinder enabling the transport bar to reciprocate in a length direction of the welding groove. And, the heat dispersion end block is reciprocated in a length direction of the welding groove by the transport means.

To further achieve these and other advantages and in accordance with the purpose of the present invention, a welding apparatus includes a welding electrode having a welding groove on which contact portions of an object to be welded are put, a heat dispersion end block provided to ends of the contact portions in a direction of welding the contact portions to prevent heat from being concentrated on the ends of the contact portions in welding the ends of the contact portions, and a transport means for making the heat dispersion end block adhere closely to the ends of the contact portions according to a length of the contact portions of the object to be welded.

Preferably, the heat dispersion end block adheres closely to the ends of the contact portions.

Preferably, a length of the welding groove is configured greater than that of the contact portions of the object to be welded.

Preferably, the heat dispersion end block is reciprocated in a length direction of the welding groove by the transport means.

Preferably, the transport means includes a transport bar fixed to one side of the heat dispersion end block and a transport cylinder enabling the transport bar to reciprocate in a length direction of the welding groove.

Preferably, the heat dispersion end block is formed of a substance having high thermal conductivity such as Cu, Fe and the like. And, a vertical thickness of the heat dispersion end block is configured greater than a thickness of the object to be welded.

To further achieve these and other advantages and in accordance with the purpose of the present invention, a method of welding a drum in a dryer includes the steps of providing a heat dispersion end block to ends of contact portions of a dryer drum sheet and welding the contact portions together.

Preferably, the method further includes a block installing step of installing the heat dispersion end block to adhere closely to the ends of the contact portions according to a length of the contact portions of the dryer drum sheet prior to the welding step.

Preferably, the method further includes a sheet loading step of loading the dryer drum sheet on a welding groove provided to a welding electrode so that the ends of the contact portions of the dryer drum sheet correspond to an end of the welding recess prior to the block installing step.

To further achieve these and other advantages and in accordance with the purpose of the present invention, in a welding apparatus comprising a welding electrode having a welding groove on which contact portions of a metal-based drum sheet are put, a heat dispersion end block provided to ends of the contact portions in a direction of welding the contact portions to prevent heat from being concentrated on the ends of the contact portions in welding the ends of the contact portions, and a transport means for making the heat dispersion end block adhere closely to the ends of the contact portions according to a length of the contact portions of the drum sheet, a method of welding a drum in a dryer includes a first step of loading the drum sheet on the welding groove of the welding electrode so that the ends of the contact portions of the drum sheet correspond to an end of the welding recess, a second step of installing the heat dispersion end block to adhere closely to the ends of the contact portions of the drum sheet by actuating the transport means, and a third step of welding the contact portions together.

Therefore, by the apparatus for welding the drum in the dryer and method thereof according to the present invention, the contact portions of the metal-based drum sheet can be accurately welded to their ends without causing a welding-affected burn by preventing heat from being concentrated on the ends of the contact portions and welded strength of the contact portions is raised to enhance overall rigidity of the drum formed by the above welding process.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is layout of drum sheet to weld contact portions of a drum sheet using a device for welding a dryer drum according to a related art;

FIG. 2 is a cross-sectional diagram taken along the contact portions in FIG. 1;

FIG. 3 is layout of drum sheet to weld contact portions of a drum sheet using an apparatus for welding a drum in a dryer according to the present invention; and

FIG. 4 is a cross-sectional diagram taken along the contact portions in FIG. 3.

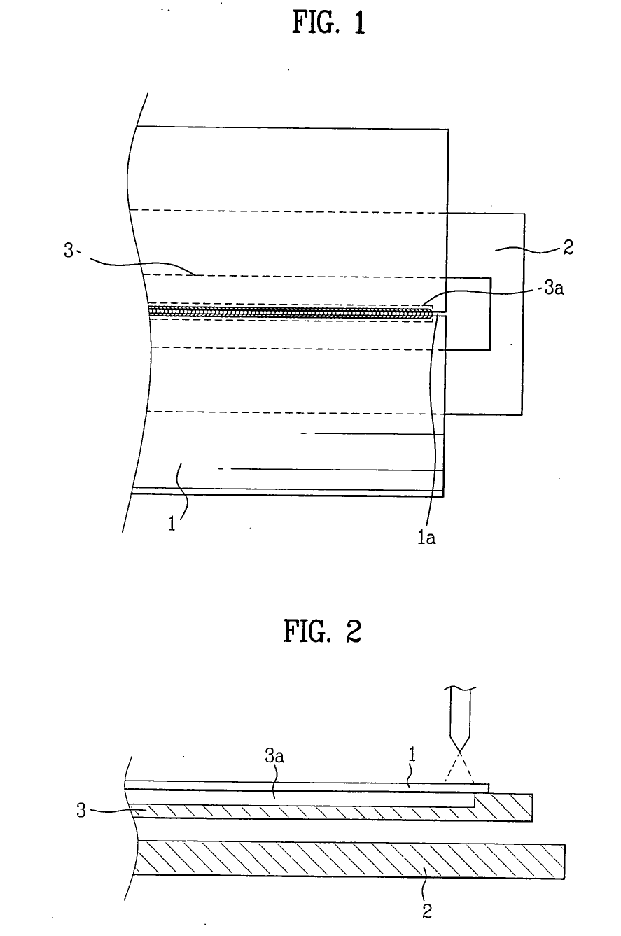

### BEST MODE FOR CARRYING OUT THE INVENTION

Reference will now be made in detail to the preferred embodiments of the present invention, examples of which are illustrated in the accompanying drawings.

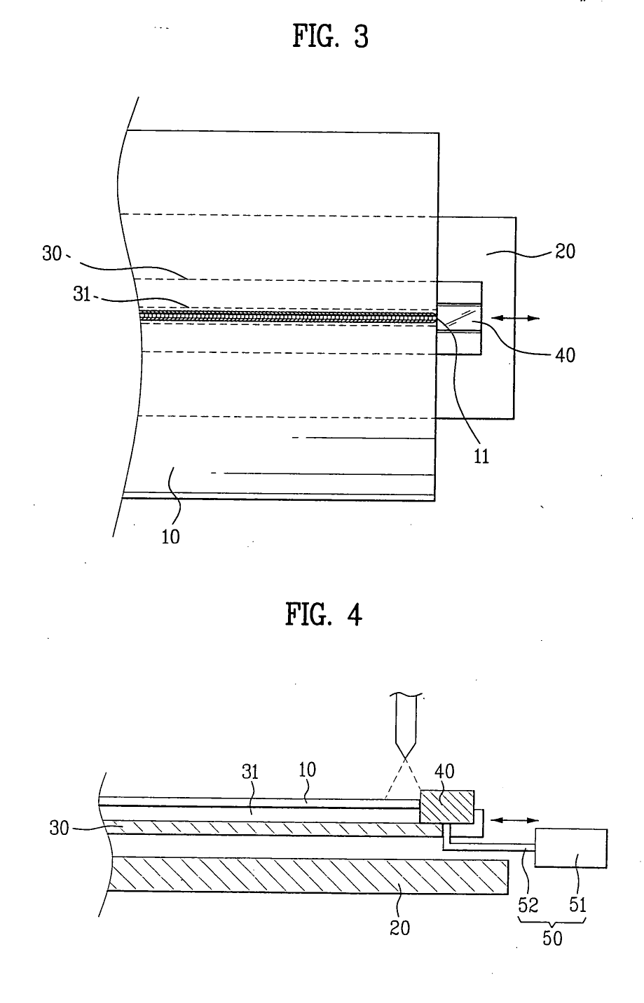

FIG. 3 is layout of drum sheet to weld contact portions of a drum sheet using an apparatus for welding a drum in a dryer according to the present invention and FIG. 4 is a cross-sectional diagram taken along the contact portions in FIG. 3.

Referring to FIG. 3 and FIG. 4, an apparatus for welding a drum in a dryer according to the present invention includes a welding electrode 30 having a welding groove 31 on which contact portions 11 of a metal-based drum sheet 10 in put and an end block 40 provided to ends of the contact portions 11 in a welding direction of the contact portions 11 for heat dispersion to prevent heat from being concentrated on the ends of the contact portions 11 in welding the ends of the contact portions 11.

And, the apparatus for welding the drum in the dryer according to the present invention further includes a transport means 50 for making the heat dispersion end block 40 adhere closely to the ends of the contact portions 11 according to length of the contact portions 11 of the drum sheet 10.

In this case, the transport means 50 includes a transport bar 52 fixed to one side of the heat dispersion end block 40 and a transport cylinder 51 enabling the transport bar 52 to reciprocate in a length direction of the welding groove 31.

And, the transport cylinder 51 may include an oil pressure cylinder that reciprocates the transport bar 52 using a solenoid.

Hence, the heat dispersion end block 40 is reciprocated in the length direction of the welding groove 31 as the transport bar 52 is reciprocated by an operation of the transport cylinder 51.

Namely, the heat dispersion end block 40 comes into adhering closely to the ends of the contact portions 11 as reciprocated by the transport means 50 to correspond to the length of the contact portions 11 of the drum sheet 10.

Meanwhile, the length of the welding groove 31 is preferably configured greater than that of the contact portions 11 of the drum sheet 10.

And, the heat dispersion end block 40 is formed of a substance having high thermal conductivity such as Cu, Fe and the like to facilitate heat, which is concentrated on the ends of the contact portions 11 in welding the ends of the contact portions 11, to be dispersed.

Preferably, a vertical thickness of the heat dispersion end block 40 is configured greater than a thickness of the drum sheet 10.

Alternatively, it is a matter of course that the transport means 50 can include any other means for reciprocating the heat dispersion end block 40.

For instance, the transport means 50 may include a rack bar having one end connected to a lower side of the heat dispersion end block 40, the rack bar having a rack running in its length direction, a pinion engaging with the rack of the rack bar, a motor having a drive shaft connected to the pinion to enable a precise control. In this case, the motor may include a stepping motor or the like.

Namely, by rotating the stepping motor forward and backward to rotate the pinion forward and backward, the rack bar having the rack is horizontally reciprocated. Hence, the heat dispersion end block 40 connected to one end of the rack bar comes into closely adhering to the ends of the contact portions 11 according to the size of the contact portions 11 of the drum sheet 10.

A method of welding contact portions of a drum sheet using the above-configured drum welding apparatus is explained as follows.

First of all, to form a cylindrical drum through a welding process, the drum sheet 10 made of such a metal-based substance as stainless and the like is rolled to form a cylindrical shape. And, the contact portions 11 of the rolled drum sheet 10 are put on the welding electrode 30 to correspond to the welding groove 30 provided to the welding electrode 30.

In doing so, the rolled drum sheet 10 is fixed so that the ends of the contact portions 11 of the rolled drum sheet 10 correspond to the end of the welding groove 31.

Subsequently, the transport cylinder 51 is actuated so that the heat dispersion end block 40 can adhere closely to the ends of the contact portions of the rolled drum sheet 10.

The contact portions 11 of the rolled drum sheet 10 are then welded together to complete the cylindrical shape of the drum sheet 10.

In doing so, since the heat dispersion end block 40 closely adheres to the ends of the contact portions 11 of the roller sheet 10, the ends of the contact portions 11 can be welded together without causing the welding-affected burn thereto.

Namely, in case of the heat generated from arc becomes concentrated on the ends of the contact portions 11 at the time point of welding the ends of the contact portions 11 in welding the contact portions 11, the heat dispersion end block 40 absorbs to disperse the heat concentrated on the ends of the contact portions 11. Hence, it is able to prevent the welding-affected burn generated from the melted ends of the contact portions 11.

Therefore, the welded strength of the contact portions 11 of the drum sheet 10 is raised to enhance the overall rigidity of the cylindrically welded drum.

### INDUSTRIAL APPLICABILITY

Accordingly, the present invention provides the following effects or advantages.

First of all, the contact portions of the metal-based drum sheet can be welded to their ends without causing the welding-affected burn by preventing heat from being concentrated on the ends of the contact portions, whereby the welded strength of the contact portions is raised.

Secondly, by raising the welded strength of the contact portions, the rigidity of the cylindrically welded drum is enhanced to extend an endurance of the drum.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A welding apparatus comprising:
a welding electrode having a welding groove on which contact portions of an object to be welded are put; and
a heat dispersion end block provided to ends of the contact portions in a direction of welding the contact portions to prevent heat from being concentrated on the ends of the contact portions in welding the ends of the contact portions.

2. The welding apparatus of claim 1, wherein the heat dispersion end block adheres closely to the ends of the contact portions.

3. The welding apparatus of claim 1, wherein a length of the welding groove is configured greater than that of the contact portions of the object to be welded.

4. The welding apparatus of claim 1, further comprising a transport means for making the heat dispersion end block adhere closely to the ends of the contact portions according to a length of the contact portions of the object to be welded.

5. The welding apparatus of claim 4, wherein the heat dispersion end block is reciprocated in a length direction of the welding groove by the transport means.

6. The welding apparatus of claim 4, the transport means comprising:
a transport bar fixed to one side of the heat dispersion end block; and
a transport cylinder enabling the transport bar to reciprocate in a length direction of the welding groove.

7. The welding apparatus of claim 1, wherein the heat dispersion end block is formed of a substance having high thermal conductivity such as Cu, Fe and the like.

8. The welding apparatus of claim 1, wherein a vertical thickness of the heat dispersion end block is configured greater than a thickness of the object to be welded.

9. A welding apparatus comprising:
a welding electrode having a welding groove on which contact portions of an object to be welded are put;
a heat dispersion end block provided to ends of the contact portions in a direction of welding the contact portions to prevent heat from being concentrated on the ends of the contact portions in welding the ends of the contact portions; and
a transport means for making the heat dispersion end block adhere closely to the ends of the contact portions according to a length of the contact portions of the object to be welded.

10. The welding apparatus of claim 9, wherein the heat dispersion end block adheres closely to the ends of the contact portions.

11. The welding apparatus of claim 9, wherein a length of the welding groove is configured greater than that of the contact portions of the object to be welded.

12. The welding apparatus of claim 9, wherein the heat dispersion end block is reciprocated in a length direction of the welding groove by the transport means.

13. The welding apparatus of claim 9, the transport means comprising:
a transport bar fixed to one side of the heat dispersion end block; and
a transport cylinder enabling the transport bar to reciprocate in a length direction of the welding groove.

14. The welding apparatus of claim 9, wherein the heat dispersion end block is formed of a substance having high thermal conductivity such as Cu, Fe and the like.

15. The welding apparatus of claim 9, wherein a vertical thickness of the heat dispersion end block is configured greater than a thickness of the object to be welded.

16. A method of welding a drum in a dryer, comprising the steps of:
providing a heat dispersion end block to ends of contact portions of a dryer drum sheet; and
welding the contact portions together.

17. The method of claim 16, further comprising a block installing step of installing the heat dispersion end block to adhere closely to the ends of the contact portions according to a length of the contact portions of the dryer drum sheet prior to the welding step.

18. The method of claim 17, further comprising a sheet loading step of loading the dryer drum sheet on a welding groove provided to a welding electrode so that the ends of the contact portions of the dryer drum sheet correspond to an end of the welding recess prior to the block installing step.

19. In a welding apparatus comprising a welding electrode having a welding groove on which contact portions of a metal-based drum sheet are put, a heat dispersion end block provided to ends of the contact portions in a direction of welding the contact portions to prevent heat from being concentrated on the ends of the contact portions in welding the ends of the contact portions, and a transport means for making the heat dispersion end block adhere closely to the ends of the contact portions according to a length of the contact portions of the drum sheet, a method of welding a drum in a dryer, comprising:
a first step of loading the drum sheet on the welding groove of the welding electrode so that the ends of the contact portions of the drum sheet correspond to an end of the welding recess;
a second step of installing the heat dispersion end block to adhere closely to the ends of the contact portions of the drum sheet by actuating the transport means; and
a third step of welding the contact portions together.
